(19) United States
(12) Patent Application Publication
(10) Pub. No.: US 2014/0078133 A1
(43) Pub. Date: Mar. 20, 2014

(54) PANEL DISPLAY APPARATUS

(71) Applicant: Novatek Microelectronics Corp., Hsinchu (TW)

(72) Inventors: Hsin-Hung Lee, Kaohsiung City (TW); Jr-Ching Lin, Hsinchu City (TW); Chia-Wei Su, Hsinchu City (TW); Po-Yu Tseng, Taoyuan County (TW); Shun-Hsun Yang, Hsinchu City (TW); Po-Hsiang Fang, Hsinchu City (TW)

(73) Assignee: Novatek Microelectronics Corp., Hsinchu (TW)

(21) Appl. No.: 14/016,135

(22) Filed: Sep. 2, 2013

(30) Foreign Application Priority Data
Sep. 17, 2012 (TW) 101134027

(51) Int. Cl. G09G 5/00

(52) U.S. Cl. CPC G09G 5/00
USPC 345/213

(57) ABSTRACT

A panel display apparatus is provided which includes a timing controller, a plurality of source drivers, a first data path, and a second data path. The first data path and the second data path are both coupled between the timing controller and the source drivers. The timing controller transmits multiple display data to the source drivers via the first data path. When the source drivers detect an event (e.g. error event), the source drivers transmit at least one event data (e.g. notification data) to the timing controller via the second data path to notify the timing controller that event correction (e.g. error correction) is needed.

### CROSS-REFERENCE TO RELATED APPLICATION

This application claims the priority benefit of Taiwan application serial no. 101134027, filed on Sep. 17, 2012. The entirety of the above-mentioned patent application is hereby incorporated by reference herein and made a part of this specification.

### BACKGROUND OF THE INVENTION

1. Field of the Invention

The present invention relates to a display apparatus, and more particularly, to a transmitting system between a source driver and a time sequence controller.

2. Description of Related Art

Following the vigorous development of semiconductor technology in recent years, flat panel displays have become more and more popular. In a panel display, a timing controller transmits digital display data to source drivers. The source drivers convert the display data into corresponding analog signals and drive a display panel with the analog signals.

The conventional transmission between the timing controller and the source drivers only employs the unidirectional transmission scheme. That is, in the conventional transmission scheme, there is only the unidirectional transmission from the timing controller to the source drivers, but there is no scheme of transmission from the source drivers back to the timing controller. However, due to system power noise or other sources of noise, the high speed bus between the timing controller and the source drivers is caused to generate errors at a certain rate. Therefore, the control signal or display data transmitted via the high speed bus has a certain degree of reliability issue. In addition, if a state machine of the source drivers and timing controller experiences an abnormity, the timing controller would not be able to learn of the status of the source drivers, which would cause a display abnormity of the system. Therefore, if the source drivers experience an abnormity, the timing controller would not able to learn of the status of the source drivers, which would cause the display panel to display an abnormal image.

### SUMMARY OF THE INVENTION

Accordingly, the present invention is directed to a panel display apparatus that provides a second data path to its source drivers. The source drivers can transmit notification data to a timing controller via the second data path to notify the timing controller of an event that needs to be corrected.

Embodiments of the present invention provide a panel display apparatus including a timing controller, a plurality of source drivers, a first data path, and a second data path. The first data path and the second data path are coupled between the timing controller and the source drivers. The timing controller transmits multiple display data to at least one of the source drivers via the first data path. When at least one of the source drivers has an event, the at least one of the source drivers transmits at least one event data to the timing controller via the second data path.

In view of the foregoing, in embodiments of the present invention, when the source driver has an error, the source driver transmits the event data to the timing controller to notify the timing controller of the error that needs to be corrected, thereby ensuring a normal image being displayed.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a diagram illustrating data transmission of a panel display apparatus according to one embodiment of the present invention.

FIG. 2 is a diagram illustrating the principle of bidirectional data transmission according to one embodiment of the present invention.

FIG. 3 is a diagram illustrating data transmission of a panel display apparatus according to one embodiment of the present invention.

FIG. 4 is a diagram illustrating a circuit architecture of the panel display apparatus of FIG. 3 according to one embodiment of the present invention.

FIG. 5 is a diagram illustrating a circuit architecture of the panel display apparatus of FIG. 3 according to one embodiment of the present invention.

FIG. 6 is a diagram illustrating a circuit architecture of the panel display apparatus of FIG. 3 according to one embodiment of the present invention.

FIG. 7 is a diagram illustrating a circuit architecture of the panel display apparatus of FIG. 3 according to one embodiment of the present invention.

FIG. 8 is a diagram illustrating a circuit architecture of the panel display apparatus of FIG. 3 according to one embodiment of the present invention.

FIG. 9 is a diagram illustrating a circuit architecture of the panel display apparatus of FIG. 3 according to one embodiment of the present invention.

### DESCRIPTION OF THE EMBODIMENTS

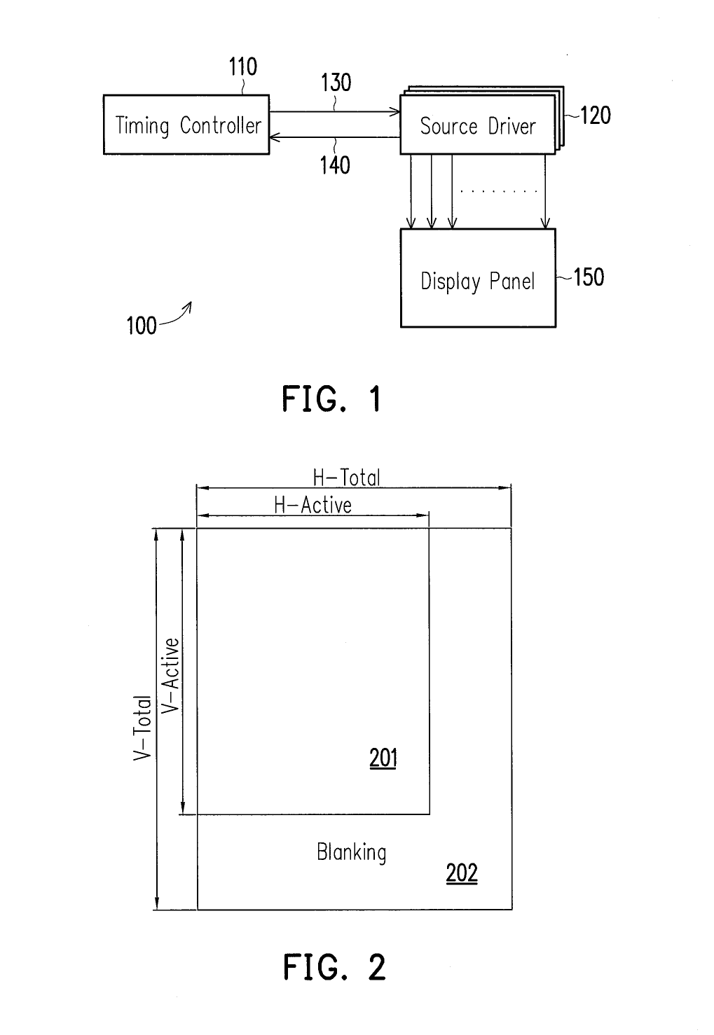

FIG. 1 is a diagram illustrating data transmission of a panel display apparatus according to one embodiment of the present invention. Referring to FIG. 1, the panel display apparatus 100 includes a timing controller 110, one or more source drivers 120, a first data path 130, a second data path 140, and a display panel 150. The first data path 130 and the second data path 140 are coupled between the timing controller 110 and the source driver 120.

The timing controller 110 can transmit digital display data (and/or control signal) to the source drivers 120 via the data path 130. The source drivers 120 convert the display data into corresponding analog signals to drive the display panel 150 with the analog signals.

When an event occurs at the source driver, for example, when the source driver 120 detects that the display data (or control signal) transmitted via the data path 130 has an error, or the source driver 120 detects that a state machine of the source driver 120 is experiencing an abnormity, the source driver 120 can transmit an event data (e.g. notification data) to the timing controller 110 via the data path 140. For example, when at least one of the multiple source drivers 120 detects that the display data transmitted via the data path 130 has an error, the at least one of the multiple source drivers 120 transmits at least one notification data to the timing controller 110 via the data path 140 to notify the timing controller 110 of the error of the transmitted data. The source driver 120 may detect the error of the display data using a scheme of checksum bit comparison. In transmitting the display data to the source driver 120, the timing controller 110 may add a checksum bit to each sub-pixel of the display data. Upon receiving the display data and the checksum bits, the source driver 120 checks whether each sub-pixel is erroneous according to the corresponding checksum bit.

From the notification data transmitted via the data path 140, the timing controller 110 can learn of whether the source driver 120 has an error and the type of the error such that the timing controller 110 can take corresponding corrective actions. For example, after the timing controller 110 is notified that the transmitted display data has an error, the timing controller 110 can re-transmit the correct display data to the source driver 120 via the data path 130. For another example, after the timing controller 110 is notified that the state machine of the source driver 120 is experiencing an abnormity, the timing controller 110 can transmit control data to the source driver 120 via the data path 130. This control data may cause the state machine of the source driver 120 to be reset to an initial state.

The above data path 130 and data path 140 may be different buses. In another embodiment, the data path 130 and the data path 140 may be the same bidirectional bus. FIG. 2 is a diagram illustrating the principle of bidirectional data transmission according to one embodiment of the present invention. Referring to FIG. 2, the time (data space) of one frame transmitted via the bus from the timing controller 110 to the source driver 120 is divided into an active area 201 occupied by the display data and a blanking space 202 not occupied by the display data. The entire data space is obtained by multiplying a total horizontal length H-Total and a total vertical length V-Total. The active area 201 is obtained by multiplying a horizontal active length H-Active and a vertical active length V-Active. To the timing controller 110, the horizontal active length H-Active and the vertical active length V-Active are known. Therefore, the timing controller 110 knows when the data transmission process arrives at the blanking space 202. When the data transmission process arrive at the blanking space 202, the timing controller 110 can transmit a packet to the source driver 120 and then immediately stop the transmission, and release the use authority of the bus to the source driver 120. Upon receiving the packet, the source driver 120 can transmit the notification data to the timing controller 110 via the same bus. After transmission of the notification data is completed, the source driver 120 transmits a packet to the timing controller 110 and then immediately stops the transmission so as to return the use authority of the bus back to the timing controller 110. Therefore, the bidirectional transmission between the source driver and the timing controller via a single bus can be achieved by using the principle illustrated in FIG. 2, in which the data path 130 and the data path 140 are implemented as the same bidirectional bus.

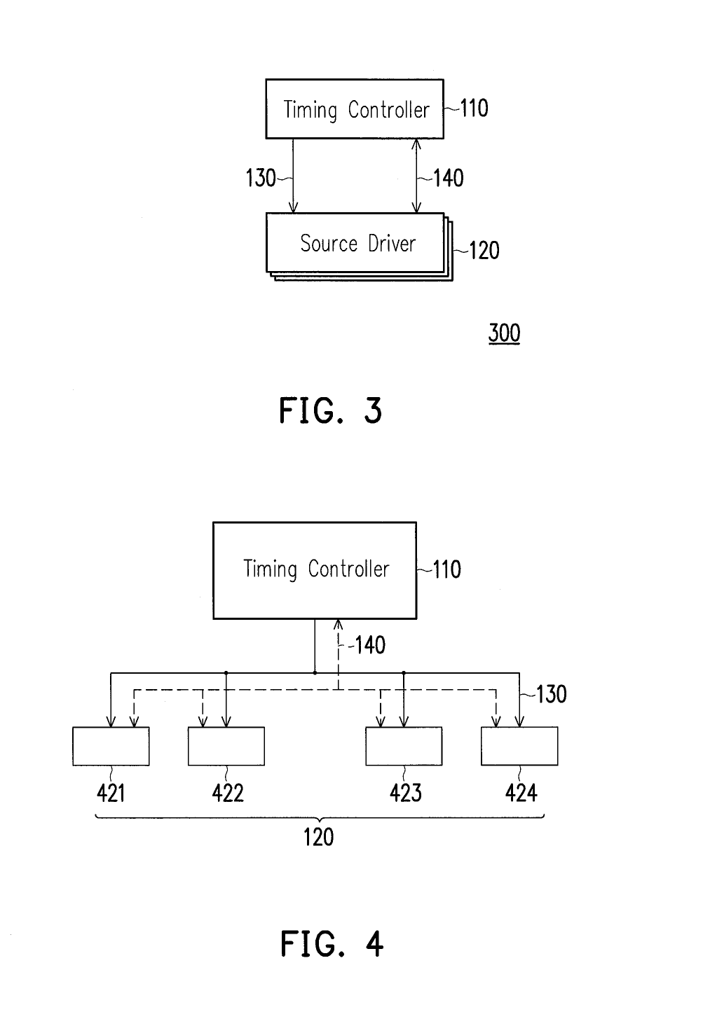

FIG. 3 is a diagram illustrating a transmitting system of a panel display apparatus according to another embodiment of the present invention. The description of FIG. 1 may be referred to for an understanding of the embodiment of FIG. 3. Different from the embodiment of FIG. 1, the second data path 140 in the embodiment of FIG. 3 is a bidirectional bus. Referring to FIG. 3, a panel display apparatus 300 includes the timing controller 110, one or more source drivers 120, the first data path 130 and the second data path 140. The timing controller 110 transmits the digital display data to the source driver 120 via the data path 130. After the source driver 120 transmits the notification data to the timing controller 110 via the data path 140, the timing controller 110 can parse the notification data and then transmit the corresponding control data to the source driver 120 via the first data path 130 or the second data path 140. For example, after the transmission of the notification data is completed, the source driver 120 continues to transmit a packet to the timing controller 110 via the data path 140 to release the use authority of the data path 140 to the timing controller 110. After receiving the notification data and obtaining the use authority of the data path 140, the timing controller 110 can transmit via the data path 140 the corresponding control data to the source driver 120 to correct the error. After transmission of the control data is completed, the timing controller 110 transmits a packet to the source driver 120 via the data path 140 and stops transmission to return the use authority of the bus (data path 140) back to the source driver 120.

The panel display apparatuses 100 and 300 can not only take corrective actions in the case of abnormity of the state machine of the source driver 120, but it also can optimize system parameters so as to enhance the efficiency of the panel display apparatus. For example, the source driver 120 can accumulate the number of errors of the display data transmitted via the data path 130 and transmit the error number data to the timing controller 110 via the data path 140. The timing controller 110 can correspondingly adjust the system parameters according to this data. For example, if the number of transmission errors is unduly large, the timing controller 110 can increase the amplitude of the display data to increase possibilities of successful transmission via the data path 130. On the contrary, if the number of the transmission errors is very small, the timing controller 110 can reduce the amplitude of the display data to reduce power consumption.

FIG. 4 is a diagram illustrating a circuit architecture of the panel display apparatus of FIG. 3 according to one embodiment of the present invention. The description of FIG. 1 to FIG. 3 may be referred to for an understanding of the embodiment of FIG. 4. Referring to FIG. 4, the panel display apparatus includes the timing controller 110, the source drivers, the data path 130 and the data path 140. The source drivers 120 include source drivers 421, 422, 423 and 424. In the present embodiment, the data path 130 employs a multi-drop architecture. The data path 140 also employs the multi-drop bus architecture, and the data path 140 has the bidirectional transmission capability. That is, the source drivers 421 to 424 can transmit notification data to the timing controller 110 via the data path 140, and the timing controller 110 can also transmit control data to the source drivers 421 to 424 via the data path 140.

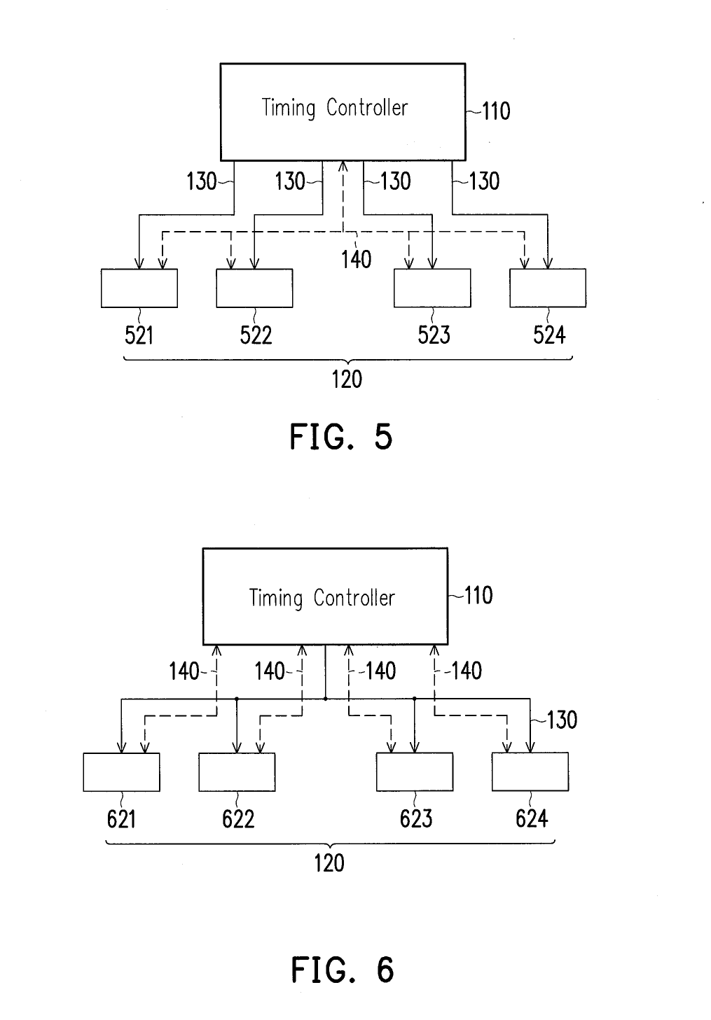

FIG. 5 is a diagram illustrating a circuit architecture of the panel display apparatus of FIG. 3 according to another embodiment of the present invention. The description of FIG. 1 to FIG. 3 may be referred to for an understanding of the embodiment of FIG. 5. Referring to FIG. 5, the source drivers 120 of the present embodiment include source drivers 521, 522, 523 and 524. In the present embodiment, the data path 130 employs a peer-to-peer (P2P) architecture. That is, the data path 130 acts as a unidirectional dedicated channel established between the timing controller 110 and each source driver 521 to 524, and each channel does not communicate with one another. In comparison with the multi-drop architecture, the P2P transmission architecture has a higher transmission rate which is suitable for current high resolution/high fresh rate applications. However, because each source driver needs a separate data line to connect to the timing controller, the circuit area of the P2P architecture is larger than the circuit area of the multi-drop bus architecture. The circuit architecture of the data path 140 is the multi-drop bus architecture and has the bidirectional transmission capability.

In one embodiment of the present invention, the data path 140 for transmitting the notification data and control data can also employ the P2P architecture. FIG. 6 is a diagram illustrating a circuit architecture of the panel display apparatus of FIG. 3 according to another embodiment of the present invention. The description of FIG. 1 to FIG. 3 may be referred to for an understanding of the embodiment of FIG. 6. Referring to FIG. 6, the source drivers 120 of the present embodiment include source drivers 621, 622, 623 and 624. In the present embodiment, the data path 130 employs the multi-drop architecture for transmitting the display data. The data path 140 employs the P2P architecture and has the bidirectional data transmission capability. Therefore, after the source drivers 621 to 624 transmit the notification data to the timing controller 110 via the data path 140, the timing controller 110 can again transmit the control data to the source drivers 621 to 624 via the data path 140.

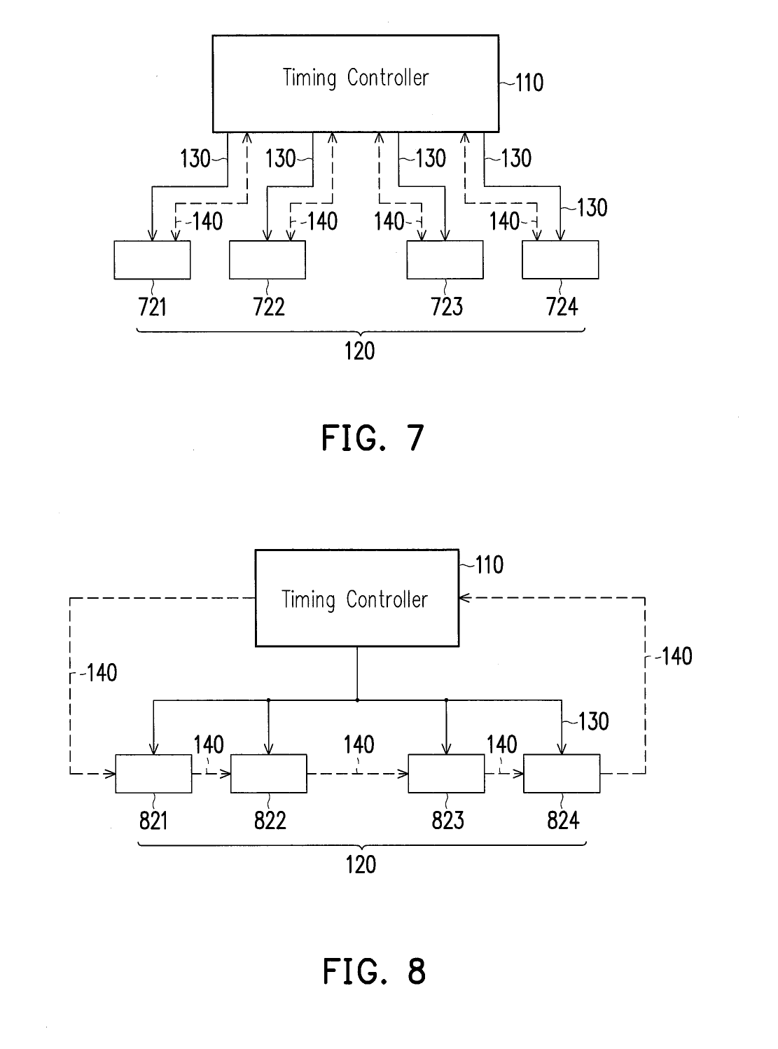

In one embodiment, the data path 130 for transmitting the display data and the data path 140 for transmitting the notification data and control data can both employ the P2P architecture. FIG. 7 is a diagram illustrating a circuit architecture of the panel display apparatus of FIG. 3 according to another embodiment of the present invention. The description of FIG. 1 to FIG. 3 may be referred to for an understanding of the embodiment of FIG. 7. Referring to FIG. 7, the source drivers 120 of the present embodiment include source drivers 721, 722, 723 and 724. In the present embodiment, the data path 130 employs the P2P architecture for transmitting the display data. The data path 140 also employs the P2P architecture and has the bidirectional data transmission capability for transmitting the notification data and control data.

FIG. 8 is a diagram illustrating a circuit architecture of the panel display apparatus of FIG. 3 according to another embodiment of the present invention. The description of FIG. 1 to FIG. 3 may be referred to for an understanding of the embodiment of FIG. 8. Referring to FIG. 8, the source drivers 120 of the present embodiment include source drivers 821, 822, 823 and 824. In the present embodiment, the data path 130 employs the multi-drop bus architecture for transmitting the display data. The data path 140 employs a cascade architecture for unidirectional transmission. When any one of the source drivers 821 to 824 detects an error, the source driver that has an error can transmit the notification data to the timing controller 110 via the data path 140. For example, when the source driver 821 detects an error, it first transmits the notification data, which is to be transmitted to the timing controller 110, to the source driver 822 via the data path 140. The source drivers 822 to 824 can assist the source driver 821 in transmitting the notification data to the timing controller 110 via the data path. After the timing controller 110 receives the notification data, the timing controller 110 can transmit the control data to the source drivers 821 to 824 via the data path 140. For example, if the timing controller 110 intends to transmit the control data to the source driver 824, the timing controller 110 can first transmit the control data to the source driver 821 via the data path 140. The source drivers 822 to 823 can assist the timing controller 110 in transmitting the control data to the source driver 824 via the data path 140.

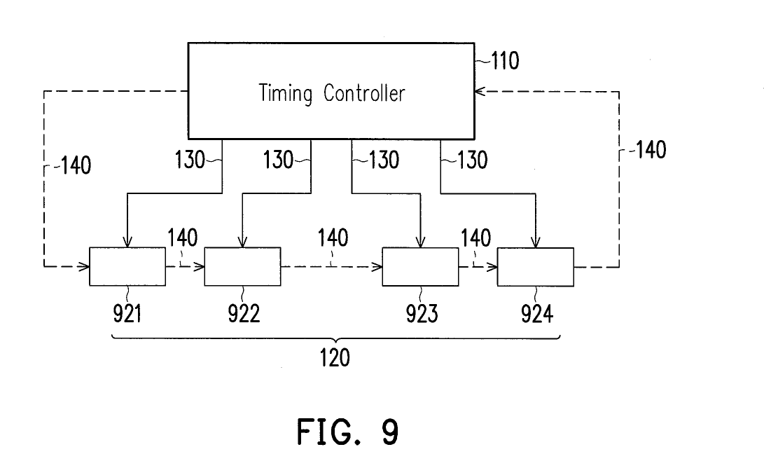

FIG. 9 is a diagram illustrating a circuit architecture of the panel display apparatus of FIG. 3 according to still another embodiment of the present invention. The description of FIG. 1 to FIG. 8 may be referred to for an understanding of the embodiment of FIG. 9. Referring to FIG. 9, the source drivers 120 of the present embodiment include source drivers 921, 922, 923 and 924. In the present embodiment, the data path 130 for transmitting the display data employs the P2P architecture. The data path 130 of the present embodiment may transmit the display data in a similar manner to the data path 130 of FIG. 5 and therefore explanation thereof is not repeated. The data path 140 for transmitting the notification data and control data employs the cascade architecture. The data path 140 may transmit the notification data and control data in a similar manner to the data path 140 of FIG. 8 and therefore explanation thereof is not repeated.

In summary, in the panel display apparatus, the timing controller 110 and each source driver 120 can perform data exchange via the original or additional data path 140. For example, the source driver 120 can detect an error of the display data and transmit the corresponding notification data back to the timing controller 110, and the timing controller can again transmit the corresponding control data to the source driver 120 to timely correct the error. In some embodiments, the data path 140 of the panel display apparatus can further have the bidirectional transmission capability. The source driver 120 can transmit the notification data to the timing controller 110 via the data path 140, and the timing controller 110 can also transmit the control data to the source driver 120 via the same data path 140. In addition, the panel display apparatus can not only correct the error, but the timing controller 110 can also automatically optimize the system parameters to increase the system performance by algorithm computation based on the exchanged data. Furthermore, in the panel display apparatus, the data path 130 for transmitting the display data can employ the multi-drop or P2P bus architecture, and the data path 140 for transmitting the notification data and control data can employ the multi-drop, P2P or cascade architecture.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A panel display apparatus comprising:
a timing controller;
a plurality of source drivers;
at least one first data path coupled between the timing controller and the source drivers, wherein the timing controller transmits multiple display data to at least one of the source drivers via the first data path; and
at least one second data path coupled between the timing controller and the source drivers, wherein, when at least one of the source drivers has an event, the at least one of the source drivers transmits at least one event data to the timing controller via the second data path.

2. The panel display apparatus according to claim 1, wherein the first data path and the second data path are the same bus.

3. The panel display apparatus according to claim 1, wherein, when the timing controller receives the event data, the timing controller correspondingly transmits at least one control data to the source drivers via the first data path or the second data path.

4. The panel display apparatus according to claim 3, wherein if a state machine of one of the source drivers experiences an abnormity, the control data causes one of the source drivers to be reset into an initial state.

5. The panel display apparatus according to claim 1, wherein the display data have at least one checksum bit, and the source drivers check whether the display data received from the timing controller have an error based on the checksum bit.

6. The panel display apparatus according to claim 1, wherein the source drivers transmit a first system statistic data to the timing controller via the second data path, and the timing controller optimizes a system parameter according to the system statistic data.

7. The panel display apparatus according to claim 6, wherein the system statistic data comprises the number of transmission errors of the display data.

8. The panel display apparatus according to claim 7, wherein the system parameter is the amplitude of the display data.

9. The panel display apparatus according to claim 1, wherein the first data path employs a multi-drop bus architecture or a peer-to-peer architecture, and the second data path employs the multi-drop bus architecture, the peer-to-peer architecture or a cascade architecture.
